(19) United States
(12) Patent Application Publication
(10) Pub. No.: US 2025/0118320 A1
(43) Pub. Date: Apr. 10, 2025

(54) SUPERVISED LEARNING METHOD AND SYSTEM FOR EXPLICIT SPATIAL FILTERING OF SPEECH

(71) Applicant: IUCF-HYU (Industry-University Cooperation Foundation Hanyang University), Seoul (KR)

(72) Inventors: Joon-Hyuk CHANG, Seoul (KR); Jeonghwan CHOI, Seoul (KR)

(21) Appl. No.: 18/983,309

(22) Filed: Dec. 16, 2024

Related U.S. Application Data
(63) Continuation of application No. PCT/KR2023/008049, filed on Jun. 12, 2023.

(30) Foreign Application Priority Data
Jun. 27, 2022 (KR) 10-2022-0078040

(51) Int. Cl. G10L 21/0216; G10L 21/0208; G10L 21/034; G10L 21/0364; G10L 25/30

(52) U.S. Cl. CPC G10L 21/0216; G10L 21/034; G10L 21/0364; G10L 25/30; G10L 2021/02082; G10L 2021/02166

(57) ABSTRACT

A supervised learning method and system for explicit spatial filtering of speech are disclosed. According to an embodiment, the supervised learning method for spatial filtering of speech, performed by a beamformer learning system, includes: receiving, as input into a neural network-based beamformer model, a multi-channel speech signal incident on a microarray in a reverberant environment and a beam condition representing the direction of interest (DOI); and outputting a desired signal corresponding to the beam condition from the multi-channel speech signal by using the neural network-based beamformer model, wherein the neural network-based beamformer model is trained to extract a speech signal with azimuth and elevation angles that are set for the beam condition, by using training data.

### TECHNICAL FIELD

The following description relates to a learning technology for spatial filtering of speech.

### BACKGROUND ART

Neural beamformers are being widely studied in speech signal processing. Neural beamformers were optimized to improve the recognition performance instead of the quality of the speech signal. Neural beamformers were proposed as preprocessors for automatic speech recognition systems, and were jointly trained with the neural network-based acoustic model to improve the recognition performance instead of the quality of the speech signal. Moreover, neural beamformer technologies for speech separation or enhancement were demonstrated. Most of them focused on designing a network architecture to improve the performance of evaluation metrics, and their effects on spatial filtering have not been discussed in detail. Several studies on neural beamformers for extracting a speech signal incident from a specific direction have been presented. These neural beamformers require direction-of-arrival (DOA) information, specifying the target signal, and exploiting the directional features based on the DOA for time-frequency mask estimation. However, accurate DOA information is required, and it can be difficult to predict the degradation of the output signal inferred from the incorrectly estimated DOA. In this regard, a technology for training neural beamformers to extract the speech signal located nearest to the target DOA using pre-defined look directions, instead of accurately estimating the DOA. COSNet can help steer toward any direction and adjust the beamwidth. Unlike the aforementioned methods, it can specify a spatial range for separation by conditioning the beamwidth and steering by aligning the time sample for the desired direction. However, the time delay for azimuth steering is considered, which depends on elevation. Moreover, a high sampling rate is required to accurately align samples in the time-domain, and it depends on the spacing between adjacent microphones.

In previous studies, the target signal was set as a reverberant signal. This complicates the spatial filtering problem as early reflections are as directional as their direct paths in a reverberant environment. In this way, in the case of existing studies on multi-channel speech enhancement based on neural networks, there was a lack of discussion on explicit learning methods for spatial filtering.

### DISCLOSURE

### Technical Problem

The present disclosure provides a method and system for training a neural network-based beamformer model to extract a speech signal incident from an arbitrary direction specified by azimuth and elevation angles.

The present disclosure provides a method and system for defining a desired signal for spatial filtering in a reverberant environment by considering not only direct paths but also the directivity of early reflections.

### Technical Solution

An embodiment of the present disclosure provides a supervised learning method for spatial filtering of speech, performed by a beamformer learning system, the method including: receiving, as input into a neural network-based beamformer model, a multi-channel speech signal incident on a microarray in a reverberant environment and a beam condition representing the direction of interest (DOI); and outputting a desired signal corresponding to the beam condition from the multi-channel speech signal by using the neural network-based beamformer model, wherein the neural network-based beamformer model is trained to extract a speech signal with azimuth and elevation angles that are set for the beam condition, by using training data.

In the supervised learning method for spatial filtering of speech, spatial gain functions may be configured to define a desired signal determined according to the beam condition, wherein the spatial gain functions include a hard gain function and a soft gain function.

The receiving may include generating training data to train the neural network-based beamformer model with a spatial filter using a supervised learning method.

The receiving may include determining a beam condition for look direction and beamwidth through early reflections multiplied by spatial gain and multiple different combinations for the source position and DOI parameters.

The receiving may include obtaining single-path propagations of the early reflections by using the direction-of-arrival (DOA) of a direct path in multiple paths and an image method.

The receiving may include defining DOI information for specifying direction information and a range of interest in a three-dimensional space, and converting the defined DOI information into a beam condition vector.

Another embodiment of the present disclosure provides a beamformer learning system including: a beam condition input part that receives, as input into a neural network-based beamformer model, a multi-channel speech signal incident on a microarray in a reverberant environment and a beam condition representing the direction of interest (DOI); and a signal output part that outputs a desired signal corresponding to the beam condition from the multi-channel speech signal by using the neural network-based beamformer model, wherein the neural network-based beamformer model is trained to extract a speech signal with azimuth and elevation angles that are set for the beam condition, by using training data.

### Advantageous Effects

In the conventional art, directivity in a reverberant environment is determined by considering direct paths alone, and therefore a neural network-based beamformer model was trained, not to extract a sound incident from an arbitrary direction, but to extract a sound spatially located nearest to that direction. According to an embodiment, the user is able to listen to sounds incident from a specific direction while adjusting them, since a spatially explicit learning method is proposed considering the directivity of early reflections.

### DESCRIPTION OF DRAWINGS

FIG. 1 is a diagram illustrating an overall operation of outputting a waveform for a beam condition using a neural network-based beamformer model according to an embodiment.

FIG. 2 is a block diagram illustrating a configuration of a beamformer learning system according to an embodiment.

FIG. 3 is a flowchart illustrating a supervised learning method for spatial filtering of speech in a beamformer learning system according to an embodiment.

FIG. 4 is an exemplary view illustrating a structure of a neural network-based beamformer model according to an embodiment.

FIG. 5 is a view illustrating spatial gain functions according to an embodiment.

### BEST MODE

Hereinafter, an embodiment will be described in detail with reference to the accompanying drawings.

In the embodiment, an operation for explicitly training a neural network-based beamformer model to extract a speech signal incident from an arbitrary direction specified by azimuth and elevation angles will be described. It can be applied in an electronic device equipped with a microphone array. To this end, direction-of-interest (DOI) information for specifying a specific direction and a range of interest in a three-dimensional space may be defined, and the defined DOI information may be conditioned on a model in the form of a beam condition vector. Moreover, a training data generation operation for generating spatially diverse data will be described.

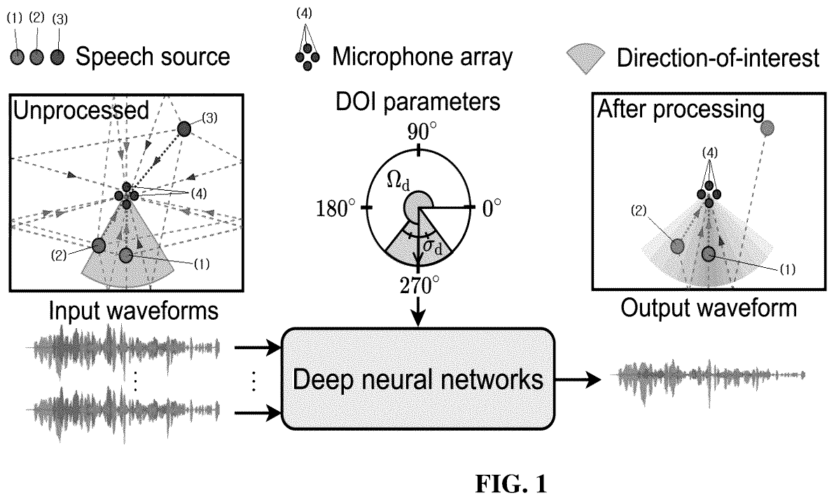

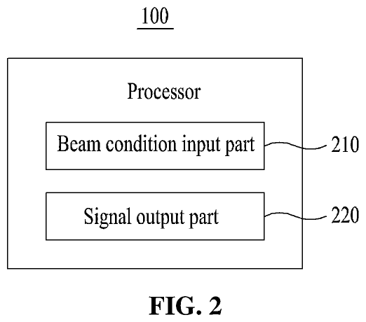

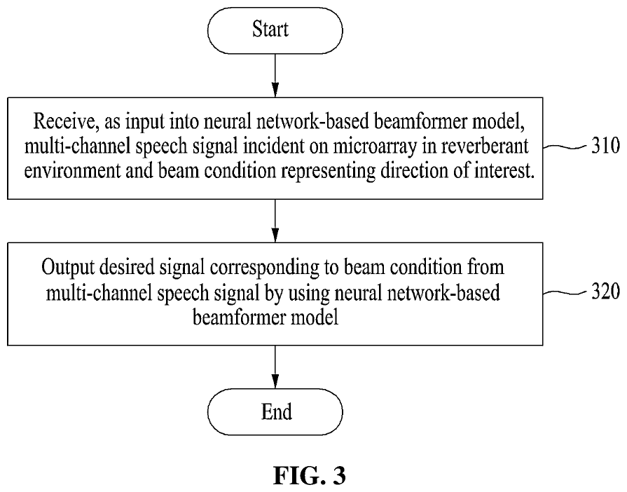

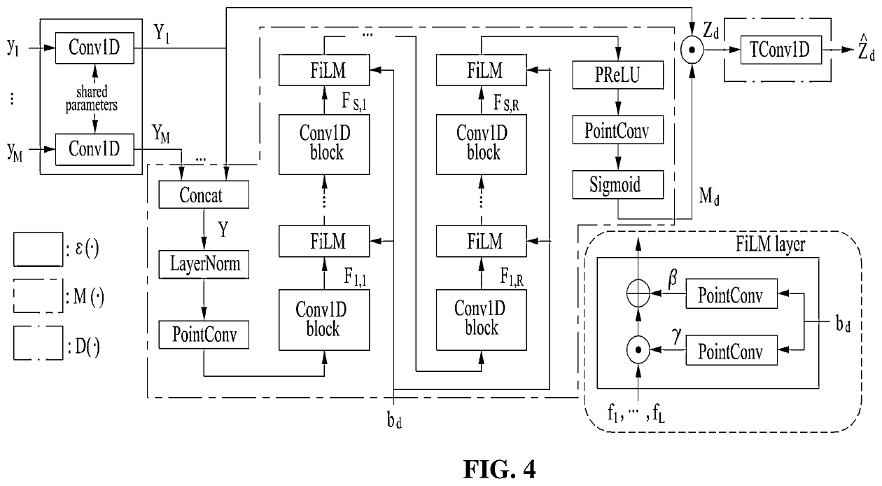

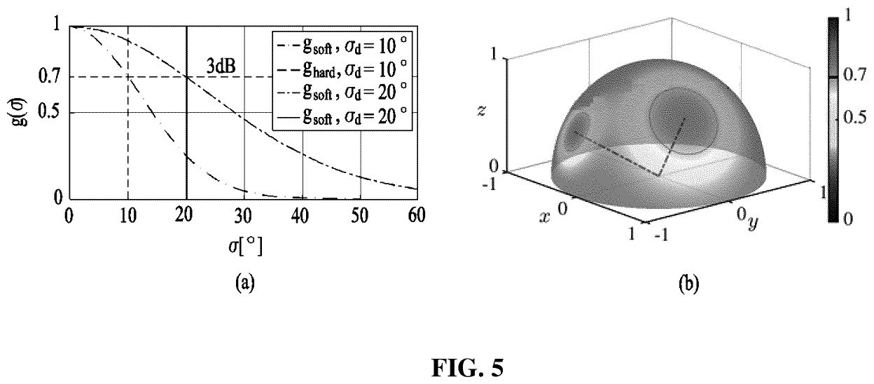

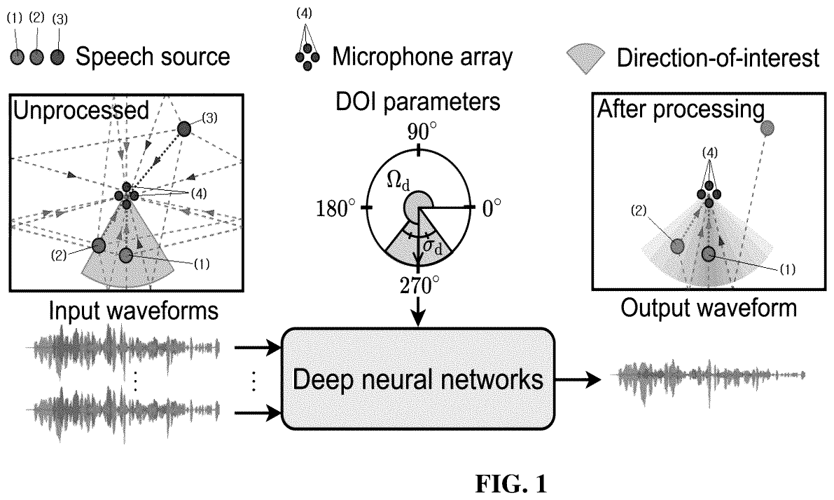

FIG. 1 is a diagram for explaining an overall operation of outputting a wave form for a beam condition using a neural network-based beamformer model according to an embodiment.

When a reverberant speech signal is incident on a microphone array, a condition called a beam condition may be inputted into a neural network-based beamformer model. In this instance, the beam condition may be adjusted by DOI parameters having azimuth and elevation angles. The beamformer model may output a waveform corresponding to the beam condition as a result.

In FIG. 1, a planar array with M microphones in a reverberant room will be considered where N speakers are uttering sound. The signal captured from the m-th microphone at time t can be written as

$${y}_{m} ( t ) = \text{?} {h}_{m} ( \text{?} t ) * {s}_{n} ( t ) + {v}_{m} ( \text{?} ) \qquad ( 1 )$$

$$\text{?} \text{indicates text missing or illegible when filed}$$

where sₙ(t) is the speech source uttered by the n-th speaker, hₘ(rₙ,t) is multipath acoustic propagation from rₙ, a relative position of a reference microphone sₙ(t), to the m-th microphone, and vₘ(t) is the spatially uncorrelated noise in the microphone.

In room acoustics, hₘ(rₙ,t) may be decomposed into direct, early reflection, and late reverberation components as follows:

$${h}_{m} ( {r}_{n} , t ) = {h}_{m}^{direct} ( {r}_{n} , t ) + {h}_{m}^{early} ( {r}_{n} , t ) + {h}_{m}^{late} ( {r}_{n} , t ) \qquad ( 2 )$$

Here, the two former terms comprise distinct directivity components with arbitrary direction-of-arrival (DOA) Ω [symbol] (θ,∅) (where θ∈[−180°, 180°] and ∅∈[0°,90°] are azimuth and elevation angles, respectively). Based on this perspective, the direct reflection paths and the early reflection paths can be expressed as

$${h}_{m}^{direct} ( {r}_{n} , t ) + {h}_{m}^{early} ( {r}_{n} , t ) = \text{?} {h}_{m}^{Ω} \text{?} ( {r}_{n} , t ) \qquad ( 3 )$$

$$\text{?} \text{indicates text missing or illegible when filed}$$

where hₘ^{Ω}^{_{I}}(rₙ,t) denotes single-path propagation with incident angle Ω_{I}, and I is the number of paths considered in the embodiment. In turn, the desired direction-of-interest (DOI) Ω_{d} can be defined as a set based on the desired DOA Ω_{d} and the beamwidth σ_{d}

$${Ω}_{d} = \{ \text{?} \vert △ {σ}_{i , d} < {σ}_{d} \} \qquad ( 4 )$$

$$\text{?} \text{indicates text missing or illegible when filed}$$

where

$$△ \text{?} = arc cos ( \text{?} \cdot \text{?} ) \qquad ( 5 )$$

$$\text{?} \text{indicates text missing or illegible when filed}$$

is the difference in the angle between Ω_{I} and Ω_{d}, and u_{Ω}=[cos θcosø,sin θcosø,sinø]^{T} denotes a unit vector corresponding to the angle Ω. Arbitrarily determining the first microphone as the reference, the desired signal can be defined as

$$\text{?} ( t ) = \text{?} ( {r}_{n} \text{?} t ) * \text{?} ( t ) \qquad ( 6 )$$

$$\text{?} \text{indicates text missing or illegible when filed}$$

where

$$\text{?} = \text{?} g ( △ {σ}_{i , d} ) \cdot {h}_{1}^{{Ω}_{d}} ( {r}_{n} , t ) \qquad ( 7 )$$

$$\text{?} \text{indicates text missing or illegible when filed}$$

is the sum of single paths in the DOI multiplied by an arbitrary spatial gain g(⋅) based on the angle difference. The present disclosure aims to extract z_{d}(t) corresponding to the desired DOI specified by Ω_{d} and σ_{d}from y₁(t), . . . ,yₘ(t)

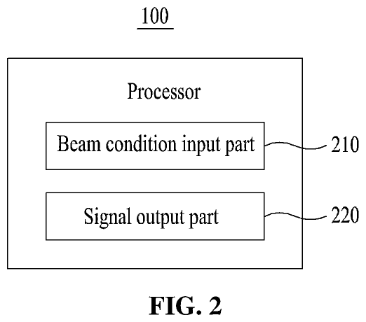

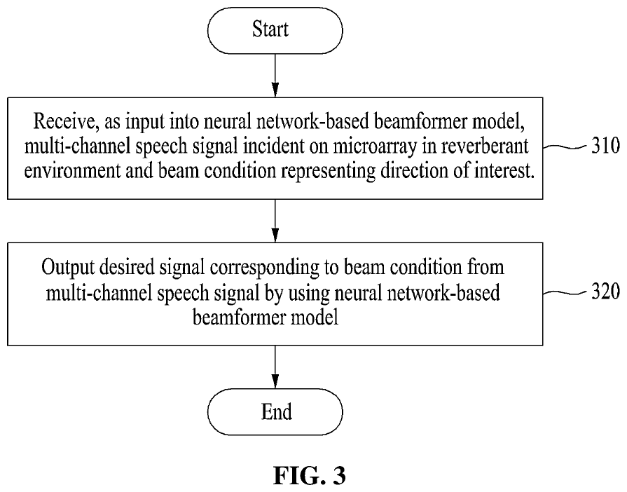

FIG. 2 is a block diagram illustrating a configuration of a beamformer learning system according to an embodiment. FIG. 3 is a flowchart illustrating a supervised learning method for spatial filtering of speech in a beamformer learning system according to an embodiment.

A processor of the beamformer learning system 100 may include a beam condition input part 210 and a signal output part 220. The components of such a processor may be representations of different functions performed by the processor in accordance with a control instruction provided by a program code stored in the beamformer learning system. The processor and the components of the processor may control the beamformer learning system to perform the steps 310 and 320 included in the supervised learning method for spatial filtering of speech in FIG. 3. Here, the processor and the components of the processor may be implemented to execute an instruction according to a code of an operating system and a code of at least one program that are included in the memory.

The processor may load, to the memory, a program code stored in a file of a program for the supervised learning method for spatial filtering of speech. For example, when a program is executed on the bearmformer learning system, the processor may control the beamformer learning system to load a program code from a file of a program under control of the operating system. Here, the beam condition input part 210 and signal output part 220 of the processor may be different functional representations of the processor to perform the following steps 310 and 320 by executing an instruction of a portion corresponding to the program code loaded to the memory.

In the step 310, the beam condition input part 210 may receive, as input into a neural network-based beamformer model, a multi-channel speech signal incident on a microarray in a reverberant environment and a beam condition representing the direction of interest (DOI). The beam condition input part 210 may define DOI information for specifying direction information and a range of interest in a three-dimensional space, and convert the defined DOI information into a beam condition vector. The beam condition input part 210 may generate training data to train the neural network-based beamformer model with a spatial filter using a supervised learning method. The beam condition input part 210 may determine a beam condition for look direction and beamwidth through early reflections multiplied by spatial gain and multiple different combinations for the source position and DOI parameters. The beam condition input part 210 may obtain single-path propagations of the early reflections by using the DOA of a direct path in multiple paths and an image method.

In the step 320, the signal output part 220 may output a desired signal corresponding to the beam condition from the multi-channel speech signal by using the neural network-based beamformer model. The signal output part 220 may extract a desired signal for spatial filtering in a reverberant environment by considering the direct path and the directivity of early reflections based on the inputted beam condition.

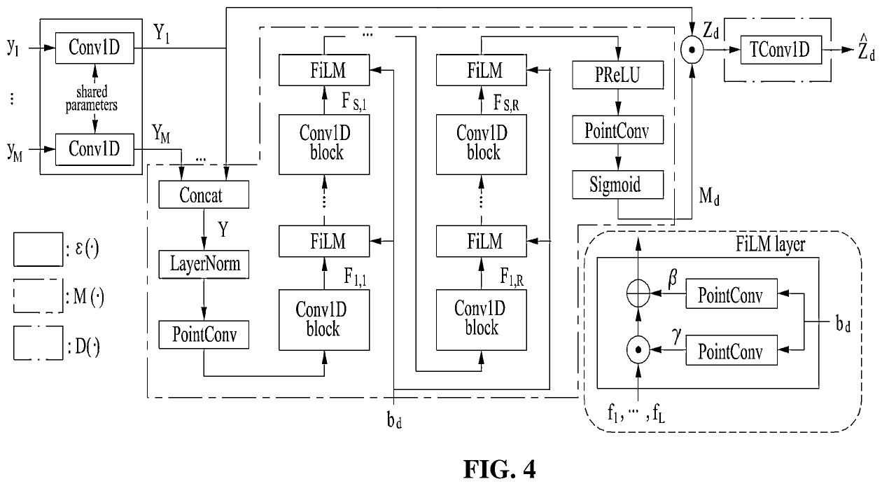

FIG. 4 illustrates a structure of a neural network-based beamformer model according to an embodiment of the present disclosure. Here, the neural network-based beamformer model may be configured in a structure including FiLM. The neural network-based beamformer model is applicable to an arbitrary speech separation module capable of receiving a beam condition as input. For ease of comprehension of the description, a structure of a neural network-based beamformer model including an encoder, a decoder, and an estimator, as shown in FIG. 4, will be described by way of example.

The neural network-based beamformer model may adopt the Conv-TasNet architecture and be modified to use DOI information. The network F(⋅) may include 1-dimensional (1D) convolutional encoder (Conv1D) ε(⋅), a 1D transposed convolutional decoder (TConv1D) D(⋅), and a conditional mask estimator M(⋅).

The main part of M(⋅) is the temporal convolutional network (TCN), in which S consecutive 1D convolutional blocks (Conv1Dblock) with different dilation factors are repeated R times. The TCN may be modified by adding a feature-wise linear modulation (FiLM) layer after every Conv1Dblock to impose the desired DOI information on M(⋅). Let yₘ∈R^{1×T} be a chunk of length T in yₘ(t). The latent representation of yₘ may be obtained by feeding it to the 1D convolution encoder (Conv1d) ε(⋅) as Yₘ=ε(yₘ)∈R^{K×L}, where K and L denote the numbers of convolution kernels and frames, respectively. Y₁, . . . , Y_{M} are concatenated along the kernel dimension Y∈R_{MK×L} and are fed to layer normalization, followed by a pointwise convolutional (PointConv) layer, which transforms the kernel dimension MK to B. Let F_{s,r}∈R^{B×L} be the output of the s-th-stacked and r-th-repeated Conv1Dblock.

Ω_{d} and σ_{d} are transformed to a DOI vector b_{d}=[U_{Ω}_{_{d}}^{T}, \tilde{σ}_{d}]^{T}∈R^{4×1}, where \tilde{σ}_{d}=(σ_{d}−σₘᵢₙ)/(σₘₐₓ−σₘᵢₙ) is the normalized beamwidth with a value between zero and one, and σₘᵢₙ and σₘₐₓ denote the beamwidth parameters that are the minimum and maximum values of σ_{d}, respectively. Note that the network is trained to handle a wide range of beamwidth determined by σₘᵢₙ and σₘₐₓ. b_{d} is fed to each FiLM layer in the TCN and transformed to β_{s,r} and γ_{s,r}, which modulate F_{s,r} to impose the DOI information.

Specifically, β_{s,r} and γ_{s,r} are obtained by passing b_{d} to the PointConv layer with B convolution kernels and applied to f_{s,r,l}=F_{s,r}eₗ∈R^{B×1}, which is the 1-th frame vector of F_{s,r}, where

$$\text{?} = [ 0 , … , \text{?} , … , 0 ∈ \text{?}$$

$$\text{?} \text{indicates text missing or illegible when filed}$$

as follows: FiLM, where (f_{s,r,l}|γ_{s,r}, β_{s,r})=γ_{s,r},⊙f_{s,r,l}+β_{s,r}, where ⊙ denotes element-wise multiplication. The desired mask is obtained from M_{d}=M(Y|b_{d})∈R^{K×L}, and the latent representation of the desired signal is computed as Z_{d}=Y₁⊙M_{d}. Finally, the chunk of the desired signal may be reconstructed by passing Z_{d} to D(⋅) as follows: Z_{d}=D(Z_{d})∈R^{1×T}.

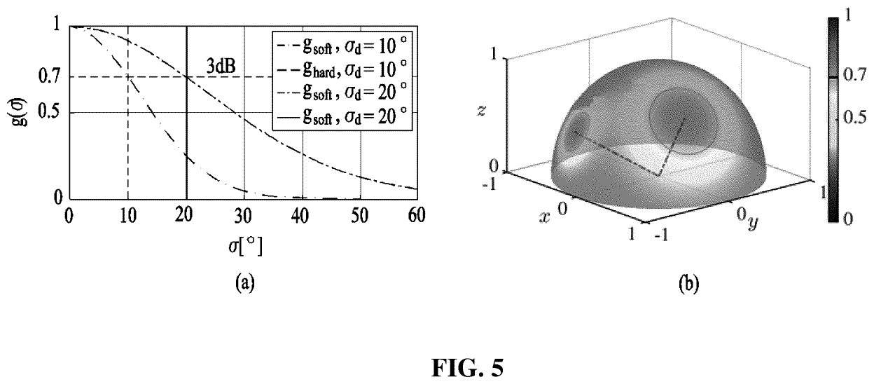

FIG. 5 is a view illustrating spatial gain functions according to an embodiment.

Spatial gain functions may be configured to define a desired signal determined according to the beam condition. (a) of FIG. 5 shows spatial gain functions, and (b) of FIG. 5 shows its visualization on the hemisphere with different values of Ω_{d}.

Two types of spatial gain functions may be considered. The hard gain function corresponds to the ideal filter and is expressed as follows:

$${g}_{hard} ( σ ) = \{ \begin{matrix}1 & σ \leq \text{?} \\ 0 & otherwise\end{matrix} \qquad ( 8 )$$

$$\text{?} \text{indicates text missing or illegible when filed}$$

Although the use of g_{hard} is intuitively ideal, its performance may depend on the number of microphones, which is limited in practice. Alternatively, the soft gain function can be used to ease abrupt changes at the σ_{d} as follows:

$$\text{?} ( σ ) = exp ( {k}_{d} ( cos σ - 1 ) ) , \qquad ( 9 )$$

$$\text{?} \text{indicates text missing or illegible when filed}$$

where k_{d}=ln(0.7071)/(cos σ_{d}−1) is a parameter that is set as a boundary corresponding to σ_{d} 3 dB beamwidth of the hard gain function.

To train a neural network-based beamformer model with an explicit spatial filter using a supervised learning method, early reflections multiplied by spatial gain and multiple different combinations of beam conditions for the source position and DOI parameters and multi-channel data for the beam conditions are needed.

In view of this, a training data generation operation will be described. First, early reflections and DOAs will be described. The direct path of hₘ(rₙ,t) can be expressed by hₘ^{direct}(rₙ,t)=δ(t−T_{m,n})/4πd_{m,n}, where δ(⋅) denotes the Kronecker delta function, and d_{m,n} and T_{m,n} are the distance and time delay-of-arrival between the m-th microphone and rₙ, respectively. The DOA of the direct path can be calculated as

$$Ω = ( a tan 2 ( \text{?} ) , arc sin ( \text{?} / ‖ \text{?} ‖ ) ) \qquad ( 10 )$$

$$\text{?} \text{indicates text missing or illegible when filed}$$

where atan2 denotes 2-argument arctangent, and ∥rₙ∥ denotes the length of rₙ.

In the image method, it is assumed that the space (room) is enclosed by rigid walls that are perfectly reflective, which implies that the position of the image source can be calculated by the symmetric transposition of the source position for the wall. For simplicity, if it is assumed that all the walls exhibit the same reflection coefficient ρ, the single-path propagation of the early reflections can be obtained as follows:

$$\text{?} ( {r}_{n} , t ) ≡ \text{?} \qquad ( 11 )$$

$$\text{?} \text{indicates text missing or illegible when filed}$$

where N₍ᵢ₎ is the number of reflections of the i=th path, and rₙ⁽ⁱ⁾ is the position of the i-th image source. Thus, I single-path propagations of the image sources and corresponding DOAs, i.e., {hₘ^{Ω}^{ᵢ}(r,t)Ωᵢ}ᵢ₋₁^{I} using Equations (10) and (11) can be calculated.

Next, desired signal generation will be described. For beam conditions, DOA parameters can be drawn from probability distributions and used to generate various combinations of the look direction and beamwidth. First, σ_{d} can be sampled from the following set {σₙ}ₙ₌₁^{N}^{_{σ}} containing N_{σ} evenly spaced elements from σₘᵢₙ to σₘₐₓ, as expressed below:

$${σ}_{d} ∼ u ( \{ \text{?} ) \qquad ( 12 )$$

$$\text{?} \text{indicates text missing or illegible when filed}$$

where u({⋅}) denotes a uniform distribution over the set {⋅}. To generate training examples for various look directions, uΩ_{d} can be drawn from the von-Mises Fisher (vMF) distribution, where the mean direction is a normalized vector randomly selected among the source positions, and k_{d} is the concentration:

$$u {Ω}_{d} ∼ vMF ( {r}_{k} / ‖ {r}_{k} ‖ , {k}_{d} ) \qquad ( 13 )$$

where k˜u{1, . . . ,N}) By doing so, the network can be trained with the various desired signals corresponding to each look direction. After the DOI parameters are determined, the desired signal (target signal) can be computed according to Algorithm 1.

Algorithm 1:
Algorithm 1 On-the fly generation of training data.

```
// Generate input signal and DOI parameters
Sample N source position from the set {rₙ}ₙ₌₁^{No}
  Load the {hₘ (r₁, t)}ₘ₌₁^{M} ,...,{hₘ(r_{N},t)ₘ₌₁^{M}
  Compute mixture signals y₁(t),...,y_{M}(t) using Eq.(1)
  Sample DOI parameters σ_{d} and Ω_{d} using Eqs. (12) and (13)
  // Generate target signal
  Load {h₁^{Ω}ᵢ(r₁,t)Ωᵢ} [symbol] =1 [symbol]   ,..., {h₁^{Ω}i (r_{N},t)Ωᵢ } [symbol] =1 [symbol]
  Compute the difference in angles (Δσ_{i,d} ) using Eq. (5)
  Compute the spatial gains g(Δσ_{i,d}) using Eq. (8) or (9)
  Compute h₁^{Ω} [symbol] (r [symbol] ,t) using Eq. (7)
  Compute target signal z [symbol]  (t) using Eq. (6) [symbol]
indicates data missing or illegible when filed
```

### Mode for Disclosure

The apparatus described above may be implemented as a hardware component, a software component, and/or a combination of the hardware component and the software component. For example, devices and components described in the embodiments may be implemented using, for example, one or more general purpose or special purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute operating system (OS) and one or more software applications running on the operating system. The processing device may also access, store, manipulate, process, and generate data in response to execution of the software. For convenience of understanding, although one processing device is sometimes described as being used, one of ordinary skill in the art will recognize that the processing device includes a plurality of processing elements and/or a plurality of types of processing elements. For example, the processing device may include a plurality of processors or one processor and one controller. Other processing configurations are also possible, such as parallel processors.

Software may include a computer program, code, an instruction or a combination of one or more of them and may configure a processor so that it operates as desired or may instruct the processor independently or collectively. The software and/or data may be embodied in a machine, component, physical device, virtual equipment or computer storage medium or device of any type in order to be interpreted by the processor or to provide an instruction or data to the processor. The software may be distributed to computer systems connected over a network and may be stored or executed in a distributed manner. The software and data may be stored in one or more computer-readable recording media.

The method according to the embodiment may be implemented with program instructions which may be executed through various computer means, and may be recorded in computer-readable media. The computer-readable media may also include, alone or in combination, the program instructions, data files, data structures, and the like. The media may persistently store a computer-executable program or temporarily store the computer-executable program for execution or downloading. The media may be various recording means or storage means formed by a single piece of hardware or a combination of several pieces of hardware. The media are not limited to media directly connected to a certain computer system, but may be distributed over a network. Examples of the media may be those configured to store program instructions, including magnetic media such as hard disks, floppy disks, and magnetic tapes, optical media such as CD-ROMs and DVDs, and magneto-optical media such as floptical disks, ROM, RAM, and flash memory. Furthermore, other examples of the medium may include an app store in which apps are distributed, a site in which other various pieces of software are supplied or distributed, and recording media and/or store media managed in a server. Examples of the program instructions may include machine-language code, such as code written by a compiler, and high-level language code executable by a computer using an interpreter.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in a different order than described above, and/or the aforementioned elements, such as systems, structures, devices, or circuits, are combined or coupled in different forms and modes than as described above or be substituted or switched with other components or equivalents.

Therefore, other implementations, other embodiments, and equivalents to the claims are within the scope of the following claims.

1. A supervised learning method for spatial filtering of speech, performed by a beamformer learning system, the method comprising:
receiving, as input into a neural network-based beamformer model, a multi-channel speech signal incident on a microarray in a reverberant environment and a beam condition representing the direction of interest (DOI); and
outputting a desired signal corresponding to the beam condition from the multi-channel speech signal by using the neural network-based beamformer model,
wherein the neural network-based beamformer model is trained to extract a speech signal with azimuth and elevation angles that are set for the beam condition, by using training data.

2. The supervised learning method of claim 1, wherein spatial gain functions are configured to define a desired signal determined according to the beam condition,
wherein the spatial gain functions include a hard gain function and a soft gain function.

3. The supervised learning method of claim 1, wherein the receiving comprises generating training data to train the neural network-based beamformer model with a spatial filter using a supervised learning method.

4. The supervised learning method of claim 3, wherein the receiving comprises determining a beam condition for look direction and beamwidth through early reflections multiplied by spatial gain and multiple different combinations for the source position and DOI parameters.

5. The supervised learning method of claim 1, wherein the receiving comprises obtaining single-path propagations of the early reflections by using the direction-of-arrival (DOA) of a direct path in multiple paths and an image method.

6. The supervised learning method of claim 1, wherein the receiving comprises defining DOI information for specifying direction information and a range of interest in a three-dimensional space, and converting the defined DOI information into a beam condition vector.

7. A beamformer learning system comprising:
a beam condition input part that receives, as input into a neural network-based beamformer model, a multi-channel speech signal incident on a microarray in a reverberant environment and a beam condition representing the direction of interest (DOI); and
a signal output part that outputs a desired signal corresponding to the beam condition from the multi-channel speech signal by using the neural network-based beamformer model,
wherein the neural network-based beamformer model is trained to extract a speech signal with azimuth and elevation angles that are set for the beam condition, by using training data.
